(19) United States
(12) Patent Application Publication
(10) Pub. No.: US 2009/0313317 A1
(43) Pub. Date: Dec. 17, 2009

(54) Wider Delivery Of Multimedia Content

(75) Inventors: Mosur Kumaraswamy Srikant, Bangalore (IN); Mahesh Kumar Jain, Bangalore (IN); Vadlamani Gopalakrishna, Bangalore (IN)

Correspondence Address: Ashok Tankha, 36 Greenleigh Drive, Sewell, NJ, 08080, US

(73) Assignee: Integra Micro Systems (P) Ltd.

(21) Appl. No.: 12/193,772

(22) Filed: Aug. 19, 2008

(30) Foreign Application Priority Data
Jun. 12, 2008 (IN) 1429/CHE/2008

(51) Int. Cl. G06F 15/16

(52) U.S. Cl. 709/202

(57) ABSTRACT

Disclosed herein is a computer implemented method and system for streaming multimedia content available at a content server with a determinate bandwidth to multiple clients. A client agent provided on each of the clients requests a server agent on a content server for multimedia content. First connections are established to the content server by a predefined number of first clients from the requesting clients using the client agent. The predefined number is determined by the bandwidth available at the content server. The server agent then transfers the multimedia content to the first clients by utilizing the first connections. The server agent identifies the first clients for availability of a predetermined bandwidth for streaming multimedia content to second clients. Second connections are then established between the identified first clients and the second clients. The identified first clients then transfer the multimedia content to the second clients by utilizing the second connections.

### CROSS REFERENCE TO THE RELATED APPLICATION

This application claims the benefit of the non provisional patent application number 1429/CHE/2008 titled “Wider Delivery Of Multimedia Content”, filed on 12 Jun. 2008 in the Indian Patent Office.

### BACKGROUND

This invention, in general, relates to digital content communication and more specifically relates to streaming digital content to multiple clients from a transmitting station with a limited bandwidth.

The widespread use of the internet in the present day has given rise to situations where a large amount of digital content may have to be simultaneously transmitted from a source to a number of destinations. Typically a number of lossy or lossless compression algorithms may be used to cope with the stringent bandwidth usage policies set down by service providers. However, regardless of the advances in audio and video compression, transmitting an audio or video stream still takes a finite amount of bandwidth that increases with the desired quality of the transmission.

In a typical internet based multimedia stream, the requirements of bandwidth and processing power of the originating station increase in direct proportion to the number of clients receiving the stream. In order to receive an acceptable quality of audio or video stream, both sending and receiving stations require at least 256 kilobytes per second (KBps) bandwidth. However, for each additional receiving station, the sending station needs to have an additional 256 KBps bandwidth. Therefore, for four simultaneous connections, the sending station requires 1 megabyte per second (Mbps) available bandwidth. For applications such as remote education, where the intention is to reach out to many more than four locations at a time, the bandwidth requirement becomes prohibitively expensive and infeasible.

Hence, there is a need for a method and system that streams digital content to an almost unlimited number of clients without increasing the bandwidth available at the transmitting station, and also without customizing any of the available multimedia stream decoders or multimedia players.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

Disclosed herein is a method and system for streaming multimedia content available at a content server with a determinate bandwidth to multiple clients. A client agent is provided on each of the clients and a server agent is provided on a content server. When one or more of the clients require multimedia content, the client agent provided on each of the clients requests the server agent on the content server for the multimedia content. The requests may be synchronous requests or asynchronous requests for audio content, video content, textual content, animation, still images, etc. If the requests for the multimedia content are granted by the server agent, first connections are established to the content server by a predefined number of first clients from the requesting clients using the client agent. The client agent on each of the first clients establishes the first connections to the content server. The predefined number of the first clients is determined by the bandwidth available at the content server. The server agent then transfers the multimedia content to the first clients by utilizing the first connections.

The server agent identifies the first clients for availability of a predetermined bandwidth and ability of the first clients to stream the multimedia content to one or more of second clients. The predetermined bandwidth available at the first clients is utilized to stream the multimedia content to the second clients. When the second clients request for the multimedia content, second connections are established to the identified first clients by the second clients. The client agent on each of the second clients establishes the second connections to the identified first clients. The client agent on each of the identified first clients then transfers the multimedia content to the second clients by utilizing the second connections.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of streaming multimedia content available at a content server with a determinate bandwidth to multiple clients.

FIG. 2 illustrates a computer implemented system for streaming multimedia content available at a content server with a determinate bandwidth to multiple clients.

FIGS. 3A-3D exemplarily illustrate a flowchart of the steps involved in streaming multimedia content available at a content server with a determinate bandwidth to a requesting client.

### DETAILED DESCRIPTION OF THE INVENTION

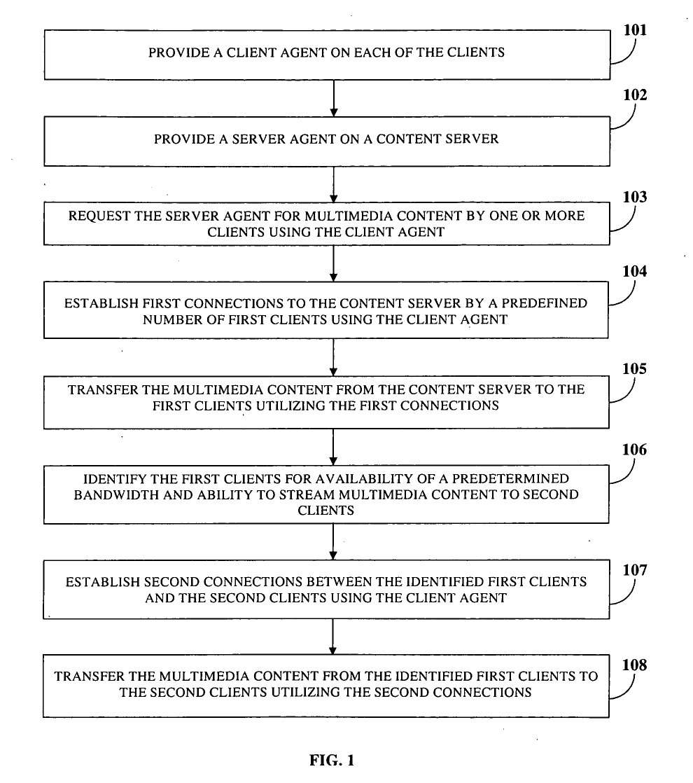

FIG. 1 illustrates a computer implemented method of streaming multimedia content available at a content server 201 with a determinate bandwidth to multiple clients 202 and 203. A client agent 202a is provided 101 on each of the clients 202 and 203. A server agent 201a is provided 102 on the content server 201. When one or more of the clients 202 and 203 require multimedia content, the client agent 202a provided on each of the clients 202 and 203 captures a request for the multimedia content from a multimedia player. The multimedia content may comprise audio content, a video content, textual content, animation, still images, and a combination thereof. The multimedia player may be any application capable of playing audio content, video content, textual content, animations, still images, etc. For example, the multimedia player may be a Windows media player of Microsoft® Corporation, a QuickTime player of Apple Inc., an Mplayer, etc.

Filler multimedia content may be introduced to occupy the period between the request being made by the multimedia player and transfer of the multimedia content to the requesting clients 202 and 203. The filler multimedia content may comprise one or more of a message such as “waiting to connect”, a short advertisement, a music video selected by a user of the multimedia player, a preview of the requested multimedia content, an available multimedia program guide, information on the current status of the network 204, etc. On capture of the request from the multimedia player, the clients 202 and 203 request 103 the server agent 201a provided on the content server 201 for multimedia content using the client agent 202a. The requests may be synchronous requests or asynchronous requests.

The server agent 201a determines whether the content server 201 is capable of handling the requests based on the total bandwidth available at the content server 201, processing power of the content server 201, and the number of clients 202 and 203 already being serviced by the content server 201. The content server 201 may be allocated a predetermined bandwidth by a service provider. The number of requesting clients 202 and 203 to be accommodated for streaming of the multimedia content is determined by the bandwidth allocated to the content server 201. The content server 201 requires additional bandwidth for every additional connection being established at the content server 201. Based on the determinate bandwidth available at the content server 201, the content server 201 may be able to transfer the multimedia content to a predefined number of the requesting clients 202 and 203. The predefined number of the requesting clients 202 and 203 are herein referred to as “first clients”. The remaining requesting clients are herein referred to as “second clients”. For purposes of illustration, the detailed description refers to multiple first clients 202 and multiple second clients 203; however the scope of the method and system disclosed herein is not limited to the first clients 202 and the second clients 203 but may be extended to include an almost unlimited number of clients and multiple levels of clients.

If the requests for the multimedia content are granted by the server agent 201a, the first clients 202 establish 104 first connections to the content server 201 using the client agent 202a. Once the first connections are established, the server agent 201a transfers 105 the multimedia content to the first clients 202 by utilizing the first connections. The client agent 202a on each of the first clients 202 then renders the transferred multimedia content to the multimedia player on each of the first clients 202.

The server agent 201a identifies 106 the first clients 202 for availability of a predetermined bandwidth and ability of the first clients 202 to stream the multimedia content to one or more of the second clients 203. The server agent 201a maintains a list of the requesting clients 202 and 203. The list comprises status information of the requesting clients 202 and 203. The status information may comprise information on bandwidth available at the requesting clients 202 and 203 and ability of the requesting clients 202 and 203 to stream the multimedia content to one or more of the second clients 203. The status information may further comprise information on network latency between the first clients 202 and the second clients 203, network latency between the clients 202 and 203 and the content server 201, network accessibility information, etc. The status information may be used by the server agent 201a to identify appropriate first clients 202 to stream the multimedia content to the second clients 203 such that the routing path distance between the first clients 202 and the second clients 203 is short. By choosing the shortest routing path, the server agent 201a may transfer the multimedia content in the least possible time.

The server agent 201a utilizes the status information to reroute the requests for the multimedia content made by the second clients 203 to the identified first clients 202 due to insufficient bandwidth available at the content server 201 to directly stream the multimedia content to the second clients 203. For example, when a new client requests for multimedia content, the server agent 201a may request the client agent 202a of the new client to check the latency between the new client and each of the already connected clients to determine if the content server 201 or one of the identified first clients 202 is suited to stream the multimedia content to the new client. The status information of the identified first clients 202 is made available to the second clients 203 by the server agent 201a. The client agent 202a on each of the second clients 203 receives and stores the status information of the identified first clients 202. The client agent 202a on each of the second clients 203 then establishes 107 second connections to the identified first clients 202. The identified first clients 202 now behave as the content server 201 and transfer 108 the multimedia content to the second clients 203 by utilizing the second connections.

When the multimedia player on each of the clients 202 and 203 makes a request for the multimedia content to the content server 201, the client agent 202a traps the requests, simulates the destination host internet protocol (IP), and establishes a connection with the multimedia player as if the client agent 202a was the original host that the multimedia player was trying to connect to. The multimedia player continues to act as if the multimedia player was connected to the original host.

The client agent 202a may also provide an interface where the user can provide the uniform resource locator (URL) that the multimedia player should connect to in order to receive the multimedia content. The client agent 202a establishes a connection with the host specified in the URL to receive the multimedia content. Simultaneously, the client agent 202a launches the multimedia player, but forces the multimedia player to connect to the client agent 202a. The client agent 202a then provides a dummy stream to connect to. The client agent 202a thus acts as a pipe, receiving the multimedia content from the server agent 201a, and forwarding the multimedia content to the multimedia player. In case of any interruption of the multimedia content, the client agent 202a introduces filler multimedia content in the multimedia player.

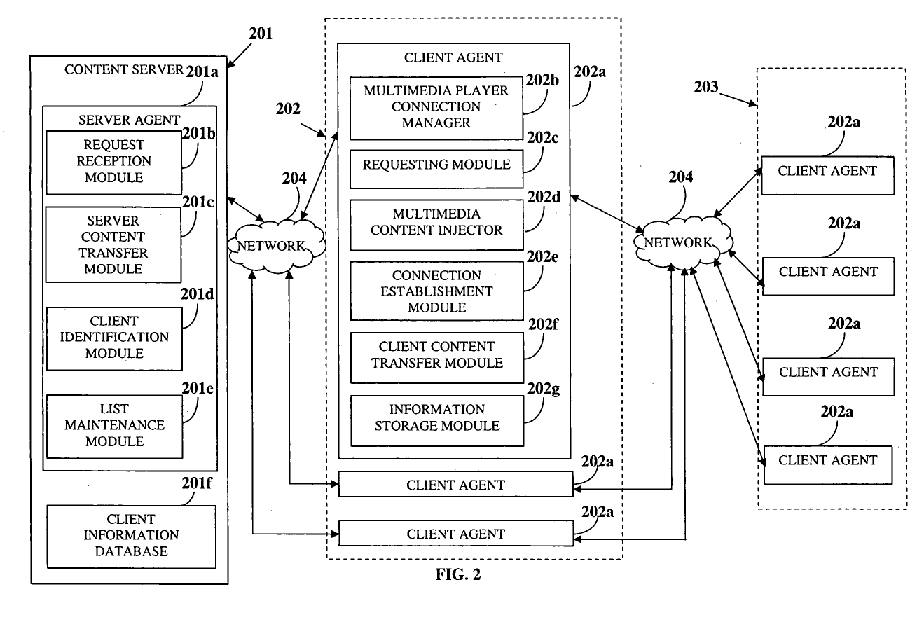

FIG. 2 illustrates a computer implemented system for streaming multimedia content available at a content server 201 with a determinate bandwidth to multiple clients 202 and 203. The system disclosed herein comprises a client agent 202a provided on each of the clients 202 and 203 and a server agent 201a provided on the content server 201. The content server 201, the first clients 202, and the second clients 203 are connected via a network 204. The client agent 202a comprises a multimedia player connection manager 202b, a requesting module 202c, a multimedia content injector 202d, a connection establishment module 202e, a client content transfer module 202f, and an information storage module 202g. The server agent 201a comprises a request reception module 201b, a server content transfer module 201c, a client identification module 201d, and a list maintenance module 201e. The content server 201 further comprises a client information database 201f.

The multimedia player connection manager 202b captures a request for the multimedia content from a multimedia player on each of the clients 202 and 203. The multimedia content injector 202d introduces filler multimedia content in the multimedia player to occupy a period between the request being made by the multimedia player and transfer of the multimedia content to the clients 202 and 203.

On capture of the request from the multimedia player, one or more of the clients 202 and 203 request the server agent 201a for multimedia content using the requesting module 202c of the client agent 202a. The request reception module 201b of the server agent 201a receives the requests for the multimedia content from the clients 202 and 203. Based on the determinate bandwidth available at the content server 201, the content server 201 may be able to transfer the multimedia content to a predefined number of first clients 202 from the requesting clients 202 and 203. The predefined number is determined by the bandwidth available at the content server 201. If the requests for the multimedia content are granted by the server agent 201a, the connection establishment module 202e of the client agent 202a on each of the first clients 202 establishes first connections to the content server 201. Once the first connections are established, the server content transfer module 201c transfers the multimedia content to the first clients 202 by utilizing the first connections. The client agent 202a on each of the first clients 202 then renders the transferred multimedia content to the multimedia player on each of the first clients 202 via the multimedia player connection manager 202b and the multimedia content injector 202d.

In case of insufficient bandwidth available at the content server 201, the client identification module 201d identifies the first clients 202 for availability of a predetermined bandwidth and ability of the first clients 202 to stream the multimedia content to one or more of the second clients 203. The list maintenance module 201e maintains a list comprising status information of the requesting clients 202. The status information comprising bandwidth available at each of the requesting clients 202 and ability of each of the requesting clients 202 to stream the multimedia content to one or more of the second clients 203 is stored in the client information database 201f.

On identifying availability of predetermined bandwidth at the first clients 202, the status information of the identified first clients 202 is sent to the second clients 203. The second clients 203 store the status information in the information storage module 202g. The connection establishment module 202e of the client agent 202a on each of the second clients 203 then establishes second connections to the identified first clients 202. The client content transfer module 202f of the client agent 202a of each of the identified first clients 202 then transfers the multimedia content from the identified first clients 202 to the second clients 203 by utilizing the second connections. The identified first clients 202 therefore, behave as the content server 201 in terms of functionality and serve the multimedia content to the second clients 203.

Similarly, multiple levels of the clients may be streamed with the multimedia content from clients previously connected to the content server 201. Since the first connections and the second connections are established by the client agent 202a on each of the clients 202 and 203, the transfer of the multimedia content is seamless without requiring intervention of the user requesting for the multimedia content. Furthermore, the multimedia content available at the content server 201 with the determinate bandwidth being streamed to multiple levels of the clients 202 and 203 enables wider delivery of the multimedia content.

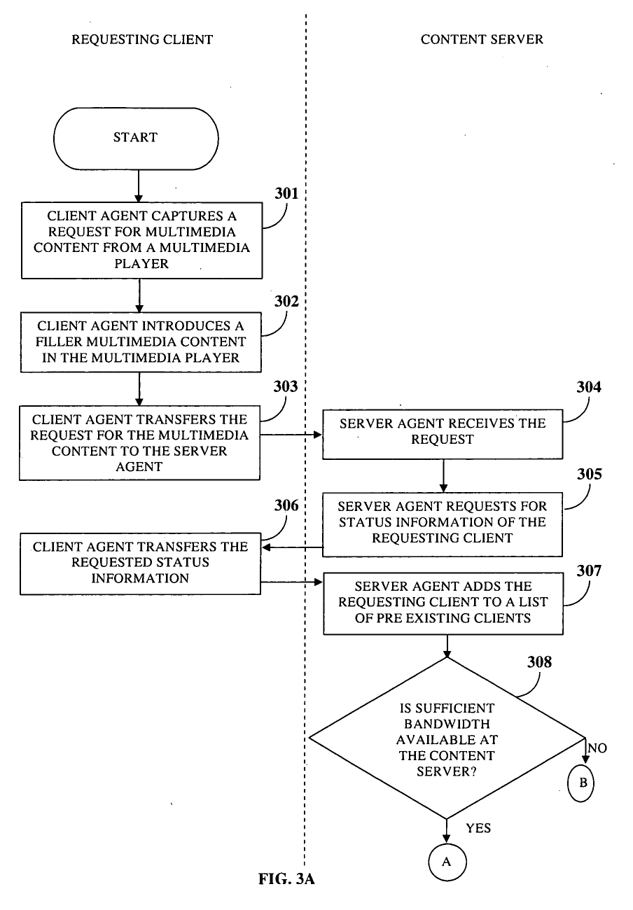

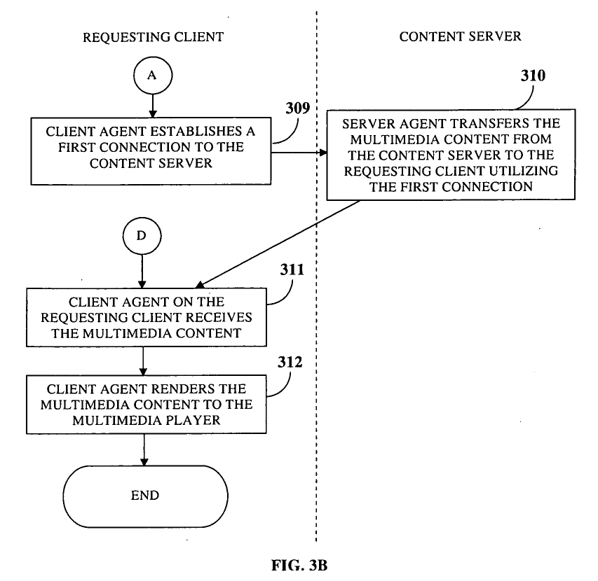

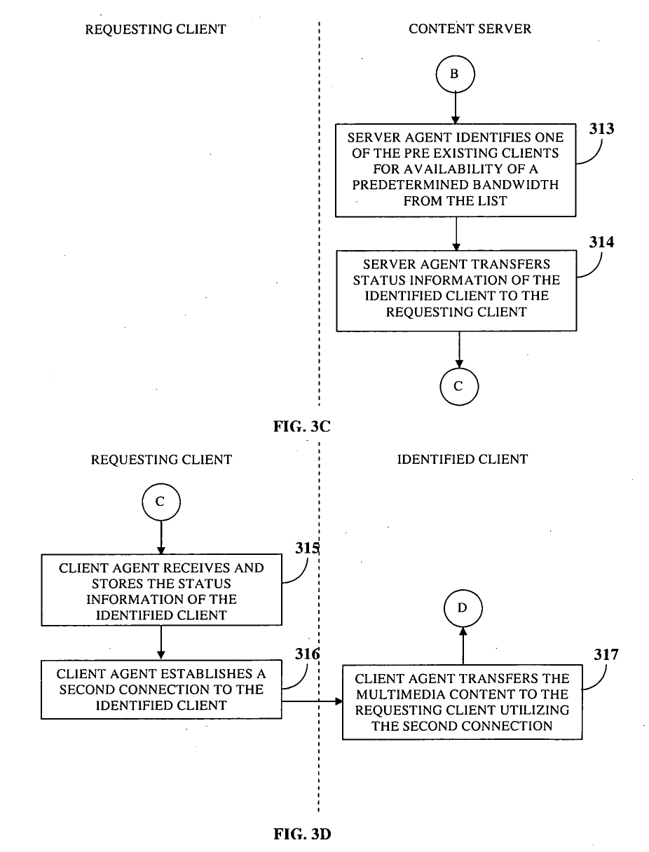

FIGS. 3A-3D exemplarily illustrate a flowchart of the steps involved in streaming multimedia content available at a content server 201 with a determinate bandwidth to a requesting client. Consider a client agent 202a provided on the requesting client and a server agent 201a provided on the content server 201. The client agent 202a captures 301 a request for multimedia content from a multimedia player on the requesting client. The request may be a synchronous request or an asynchronous request for audio content, video content, textual content, animation, still images, etc. On capture of the request from the multimedia player, the client agent 202a introduces 302 filler multimedia content in the multimedia player until the requested multimedia content is rendered. The client agent 202a transfers 303 the request for the multimedia content to the server agent 201a on the content server 201. The multimedia player starts playing immediately and keeps the user engaged. The server agent 201a receives 304 the request and requests 305 for status information of the requesting client. The client agent 202a transfers 306 the requested status information to the content server 201.

The server agent 201a then adds 307 the requesting client to a list of pre existing clients. If sufficient bandwidth is available 308 at the content server 201, the client agent 202a on the requesting client establishes 309 a first connection to the content server 201. The server agent 201a then transfers 310 the multimedia content to the requesting client utilizing the first connection. The client agent 202a on the requesting client then receives 311 the multimedia content and renders 312 the multimedia content to the multimedia player.

If sufficient bandwidth is not available 308 at the content server 201, the server agent 201a identifies 313 one of the pre existing clients from the list for availability of a predetermined bandwidth. The server agent 201a transfers 314 the status information of the identified client to the requesting client. By transferring the status information of identified client, the server agent 201a informs the requesting client of the rerouting of the client request to the identified client. The identified client will now behave as the content server 201 in order to stream the multimedia content to the requesting client. The client agent 202a receives 315 and stores the status information of the identified client. The client agent 202a on the requesting client establishes 316 a second connection to the identified client. The identified client transfers 317 the multimedia content to the requesting client utilizing the second connection. The client agent 202a on the requesting client then receives 311 the multimedia content and renders 312 the multimedia content to the multimedia player.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A processor means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product, comprising computer executable instructions embodied in a computer-readable medium, comprises computer parsable codes for the implementation of the processes of various embodiments.

Where databases are described, such as the client information database 201f, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of streaming multimedia content available at a content server with a determinate bandwidth to a plurality of clients, comprising the steps of:
providing a client agent on each of said clients;
providing a server agent on said content server;
requesting said server agent for said multimedia content by one or more of the clients using said client agent, wherein said requests are one of synchronous requests and asynchronous requests;
establishing first connections to the content server by a predefined number of first clients from said requesting clients using the client agent, wherein said predefined number of said first clients is determined by said determinate bandwidth available at the content server;
transferring the multimedia content from the content server to the first clients utilizing said first connections;
identifying the first clients for availability of a predetermined bandwidth and ability of the first clients to stream the multimedia content to one or more of a plurality of second clients, wherein said predetermined bandwidth available at the first clients is utilized to stream the multimedia content to said second clients;
establishing second connections to said identified first clients by the second clients using the client agent; and
transferring the multimedia content from the identified first clients to the second clients utilizing said second connections;
whereby the multimedia content available at the content server with the determinate bandwidth is streamed to the first clients and the second clients, thereby enabling wider delivery of the multimedia content; and
whereby the client agent on each of the first clients and the second clients allows seamless streaming of the multimedia content available at the content server to the first clients and the second clients.

2. The computer implemented method of claim 1, wherein the multimedia content comprises audio content, a video content, a textual content, animation, still images, and a combination thereof.

3. The computer implemented method of claim 1, further comprising a step of maintaining a list of the requesting clients by the server agent on the content server, wherein said list comprises status information of each of the requesting clients, wherein said status information comprises bandwidth available at each of the requesting clients and ability of each of the requesting clients to stream the multimedia content to one or more of the second clients.

4. The computer implemented method of claim 3, wherein the status information of the first clients is sent to the second clients by the server agent, wherein the status information is used to reroute the requests for the multimedia content made by the second clients from the content server to the identified first clients due to insufficient bandwidth available at the content server.

5. The computer implemented method of claim 1, wherein the server agent transfers the multimedia content from the content server to the first clients by utilizing the first connections.

6. The computer implemented method of claim 1, wherein the client agent on each of the identified first clients transfers the multimedia content from the identified first clients to the second clients by utilizing the second connections.

7. The computer implemented method of claim 1, further comprising a step of capturing a request for the multimedia content from a multimedia player by the client agent, wherein filler multimedia content is introduced to occupy a period between said request being made by said multimedia player and transfer of the multimedia content to the clients.

8. The computer implemented method of claim 7, wherein the client agent renders the multimedia content to the multimedia player.

9. A computer implemented system for streaming multimedia content available at a content server with a determinate bandwidth to a plurality of clients, comprising:
a client agent on each of said clients, comprising:
a requesting module for requesting a server agent on said content server for said multimedia content by the clients;
a connection establishment module for establishing first connections to the content server from a predefined number of first clients of said requesting clients, wherein said connection establishment module further establishes second connections from second clients to said first clients identified by said server agent for availability of a predetermined bandwidth; and
a client content transfer module for transferring the multimedia content from said identified first clients to said second clients by utilizing said second connections;
the server agent on the content server, comprising:
a server content transfer module for transferring the multimedia content from the content server to the first clients utilizing said first connections; and
a client identification module for identifying the first clients for availability of a predetermined bandwidth and ability of the first clients to stream the multimedia content to one or more of the second clients.

10. The computer implemented system of claim 9, wherein the server agent further comprises a request reception module for receiving said requests for the multimedia content from the clients.

11. The computer implemented system of claim 9, wherein the server agent on the content server further comprises a list maintenance module for maintaining a list of the requesting clients, wherein said list comprises status information of each of the requesting clients, wherein said status information comprises bandwidth available at each of the requesting clients and ability of each of the requesting clients to stream the multimedia content to one or more of the second clients.

12. The computer implemented system of claim 11, wherein the content server comprises a client information database for storing the list comprising status information of the requesting clients.

13. The computer implemented system of claim 9, wherein said client agent further comprises an information storage module for storing status information of the first clients, wherein said status information of the first clients is sent to the second clients by the server agent.

14. The computer implemented system of claim 9, wherein said client agent further comprises a multimedia player connection manager for capturing a request for the multimedia content from a multimedia player on each of the clients.

15. The computer implemented system of claim 14, wherein the client agent further comprises a multimedia content injector for introducing filler multimedia content in said multimedia player to occupy a period between said request being made by the multimedia player and transfer of the multimedia content to the clients.

16. A computer program product comprising computer executable instructions embodied in a computer-readable medium, wherein said computer program product comprises:
a first computer parsable program code for requesting a server agent on a content server for multimedia content by one or more of a plurality of clients using a client agent on each of said clients;
a second computer parsable program code for establishing first connections to said content server from a predefined number of first clients of said requesting clients using said client agent;
a third computer parsable program code for transferring said multimedia content from the content server to said first clients utilizing said first connections;
a fourth computer parsable program code for identifying the first clients for availability of a predetermined bandwidth and ability of the first clients to stream the multimedia content to one or more of a plurality of second clients;
a fifth computer parsable program code for establishing second connections to said identified first clients from said second clients using the client agent; and
a sixth computer parsable program code for transferring the multimedia content from the identified first clients to the second clients utilizing said second connections.

17. The computer program product of claim 16, further comprising a seventh computer parsable program code for maintaining a list of the requesting clients by said server agent on the content server, wherein said list comprises status information of each of the requesting clients.

18. The computer program product of claim 16, further comprising an eighth computer parsable program code for capturing a request for the multimedia content from a multimedia player on each of the clients.

19. The computer program product of claim 18, further comprising a ninth computer parsable program code for introducing filler multimedia content to occupy a period between said request being made by said multimedia player and transfer of the multimedia content to the clients.

20. The computer program product of claim 19, further comprising a tenth computer parsable program code for rendering said transferred multimedia content to the multimedia player.
